(19) United States
(12) Patent Application Publication
(10) Pub. No.: US 2026/0064742 A1
(43) Pub. Date: Mar. 5, 2026

(54) SYSTEM AND METHOD FOR GENERATING MOBILITY INSIGHTS

(71) Applicant: INRIX Inc., KIRKLAND, WA (US)

(72) Inventors: Christopher Lawrence Scofield, North Kingstown, RI (US); Bryn John Mills, Wolverhampton (GB); Uri Lavee, Tel Aviv (IL); Nicholas John Burgoyne, Stockport (GB); David Anthony Farrand, Rowley Regis (GB)

(21) Appl. No.: 18/824,311

(22) Filed: Sep. 4, 2024

(51) Int. Cl. G06F 16/33; G06F 16/332

(52) U.S. Cl. CPC G06F 16/3344; G06F 16/3329

(57) ABSTRACT

A first plan is generated for producing a natural language answer to a user request. The first plan includes identification of a first tool from a plurality of tools and identification of a first tool input to provide to the first tool. If there is not sufficient information to generate the natural language answer, then an additional tool name from the plurality of tools is identified and an additional tool input is identified to provide to the additional tool. Once there is sufficient information, the natural language answer is provided in response to the user request.

### BACKGROUND

The proliferation of inexpensive sensors has provided a wealth of information about vehicle traffic worldwide. GPS sensors in cellular phones, traffic sensors at intersections and on highways, traffic cameras at intersections are all examples of sensors that produce a rich source of information about traffic flow. In addition to these, traditional sources such as emergency vehicle reports of crashes, construction alerts and event calendars add to important intelligence about road network performance. These sources, and more, produce petabytes of both historical and current data that require special expertise to analyze. Traditionally this has been done with specialized database tools and performed by trained analysts. This both slows the process of understanding traffic flow and limits the kinds of questions that traffic network operators can ask about the networks they manage. Accordingly, there is a need for systems and methods that allow for easier access and analysis of vast sources of data, and in particular mobility-related data sources, and especially by untrained persons.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

According to some embodiments, a method is provided. The method includes providing a manager comprising a first large language model communicatively coupled to a user interface, providing a plurality of tools communicatively coupled to the manager, wherein each of the plurality of tools is configured to provide the manager with a natural language tool name that identifies the tool and a natural language description that describes the tool, receiving, by the manager, a set of user query information comprising a user request, generating, by the manager, a first plan to generate a natural language answer responsive to the user request, wherein the first plan comprises identification of a first action, wherein identification of a first action comprises identification of a first tool name from the plurality of tools and identification of a first tool input to provide to the first tool, calling, by the manager, the first tool using a first tool call, wherein the first tool call includes the first tool name and the first tool input, observing, by the manager, a first tool response, wherein the first tool response comprises a natural language observation of the information returned from the first tool, determining, by the manager, whether the manager currently has sufficient information to generate the natural language answer responsive to the user request, if the manager determines that it does not currently have sufficient information, generating, by the manager, an additional plan to generate a natural language answer responsive to the user request, wherein the additional plan comprises identification of an additional action, wherein the identification of an additional action comprises identification of an additional tool name from the plurality of tools and identification of an additional tool input to provide to the additional tool, and if the manager determines that it currently has sufficient information, generating, by the manager, the natural language answer responsive to the user request and providing the natural language answer responsive to the user request to the user interface.

According to some embodiments, a computing device is provided. The computing device includes a processor, and memory comprising processor-executable instructions that when executed by the processor cause performance of operations. The operations include providing a manager comprising a first large language model communicatively coupled to a user interface, providing a plurality of tools communicatively coupled to the manager, wherein each of the plurality of tools is configured to provide the manager with a natural language tool name that identifies the tool and a natural language description that describes the tool, receiving, by the manager, a set of user query information comprising a user request, generating, by the manager, a first plan to generate a natural language answer responsive to the user request, wherein the first plan comprises identification of a first action, wherein identification of a first action comprises identification of a first tool name from the plurality of tools and identification of a first tool input to provide to the first tool, calling, by the manager, the first tool using a first tool call, wherein the first tool call includes the first tool name and the first tool input, observing, by the manager, a first tool response, wherein the first tool response comprises a natural language observation of the information returned from the first tool, determining, by the manager, whether the manager currently has sufficient information to generate the natural language answer responsive to the user request, if the manager determines that it does not currently have sufficient information, generating, by the manager, an additional plan to generate a natural language answer responsive to the user request, wherein the additional plan comprises identification of an additional action, wherein the identification of an additional action comprises identification of an additional tool name from the plurality of tools and identification of an additional tool input to provide to the additional tool, and if the manager determines that it currently has sufficient information, generating, by the manager, the natural language answer responsive to the user request and providing the natural language answer responsive to the user request to the user interface.

According to some embodiments, a non-transitory machine readable medium is provided. The non-transitory machine readable medium has stored thereon processor-executable instructions that when executed cause performance of operations. The operations include providing a manager comprising a first large language model communicatively coupled to a user interface, providing a plurality of tools communicatively coupled to the manager, wherein each of the plurality of tools is configured to provide the manager with a natural language tool name that identifies the tool and a natural language description that describes the tool, receiving, by the manager, a set of user query information comprising a user request, generating, by the manager, a first plan to generate a natural language answer responsive to the user request, wherein the first plan comprises identification of a first action, wherein identification of a first action comprises identification of a first tool name from the plurality of tools and identification of a first tool input to provide to the first tool, calling, by the manager, the first tool using a first tool call, wherein the first tool call includes the first tool name and the first tool input, observing, by the manager, a first tool response, wherein the first tool response comprises a natural language observation of the information returned from the first tool, determining, by the manager, whether the manager currently has sufficient information to generate the natural language answer responsive to the user request, if the manager determines that it does not currently have sufficient information, generating, by the manager, an additional plan to generate a natural language answer responsive to the user request, wherein the additional plan comprises identification of an additional action, wherein the identification of an additional action comprises identification of an additional tool name from the plurality of tools and identification of an additional tool input to provide to the additional tool, and if the manager determines that it currently has sufficient information, generating, by the manager, the natural language answer responsive to the user request and providing the natural language answer responsive to the user request to the user interface.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is a flow diagram illustrating an exemplary method of generating mobility insights, in accordance with one or more embodiments set forth herein.

FIG. 2A is a component block diagram illustrating an exemplary system for generating mobility insights, in accordance with one or more embodiments set forth herein.

FIG. 2B is a component block diagram illustrating the exemplary system of FIG. 2A, having an enlarged view of the manager portion.

FIG. 3A is a component block diagram illustrating an exemplary system for generating mobility insights, having an enlarged view of an exemplary graphical user interface portion, in accordance with one or more embodiments set forth herein.

FIG. 3B is an illustration of another exemplary graphical user interface, in accordance with one or more embodiments set forth herein.

FIG. 4 is an illustration of an exemplary work flow of a system for generating mobility insights, in accordance with one or more embodiments set forth herein.

FIG. 5 is an illustration of an exemplary work flow of a system for generating mobility insights, in accordance with one or more embodiments set forth herein.

FIG. 6 is an illustration of an exemplary computer readable medium wherein processor-executable instructions configured to embody one or more of the provisions set forth herein may be comprised.

FIG. 7 illustrates an exemplary computing environment wherein one or more of the provisions set forth herein may be implemented.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

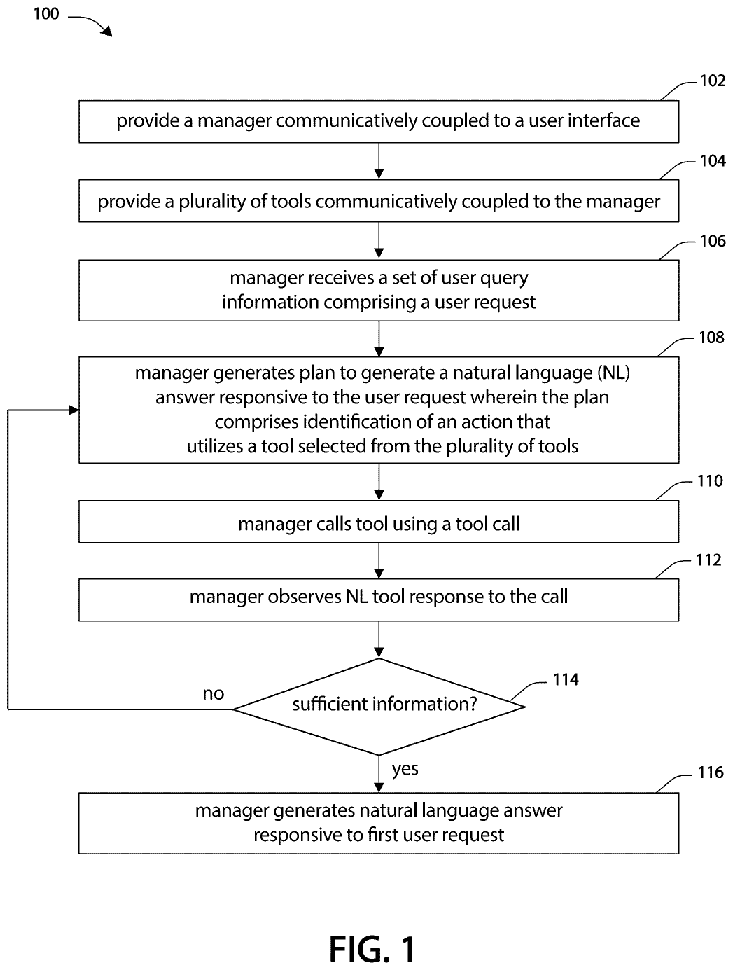

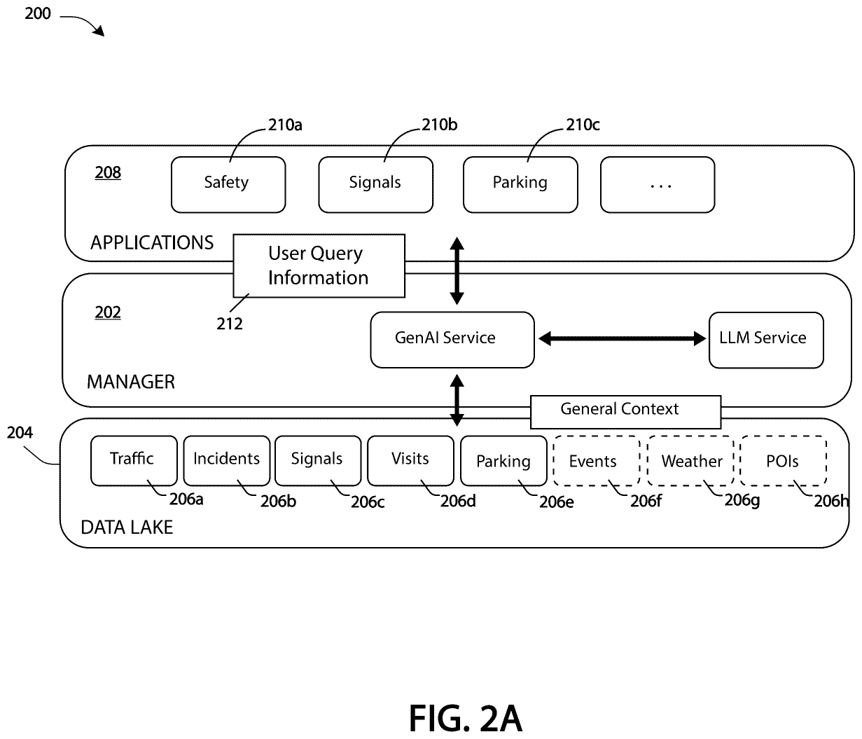

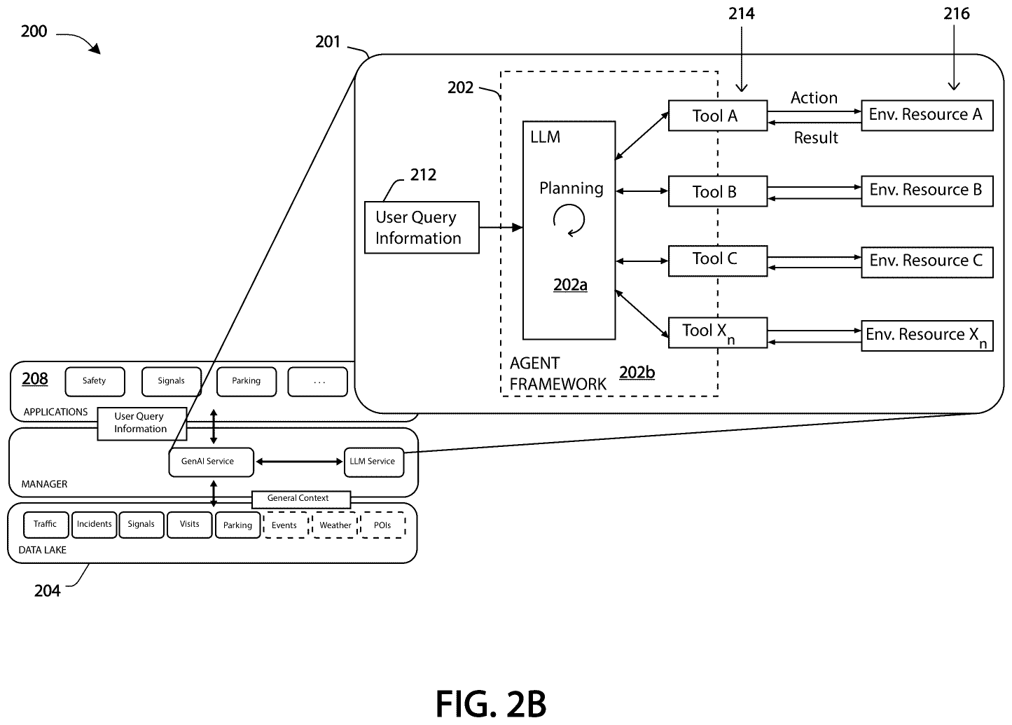

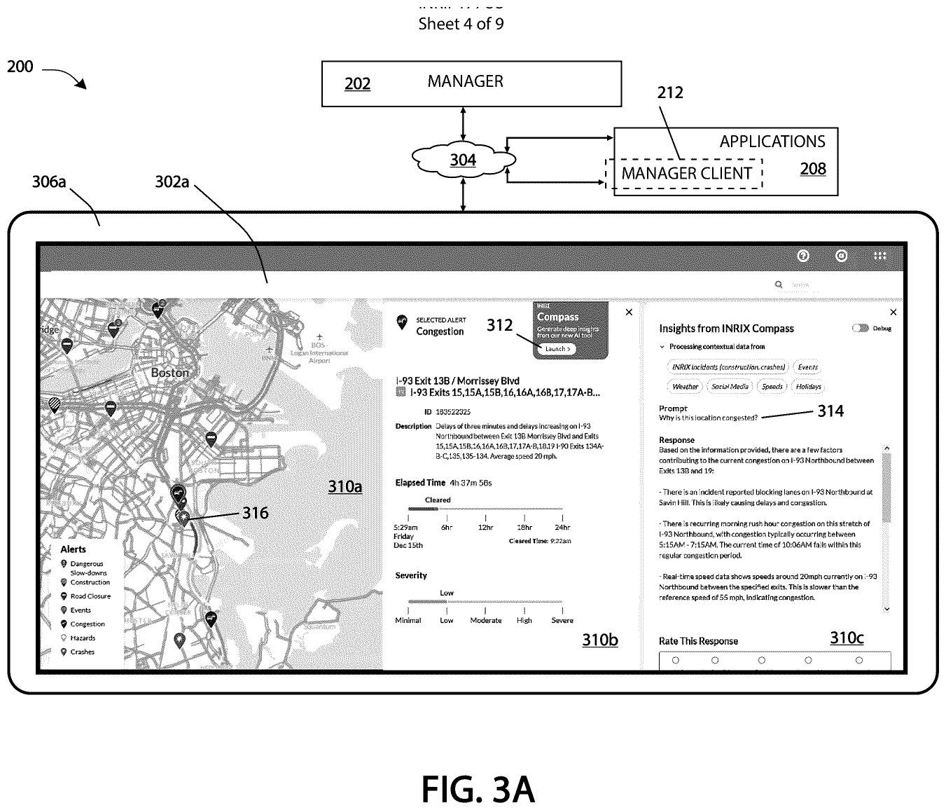

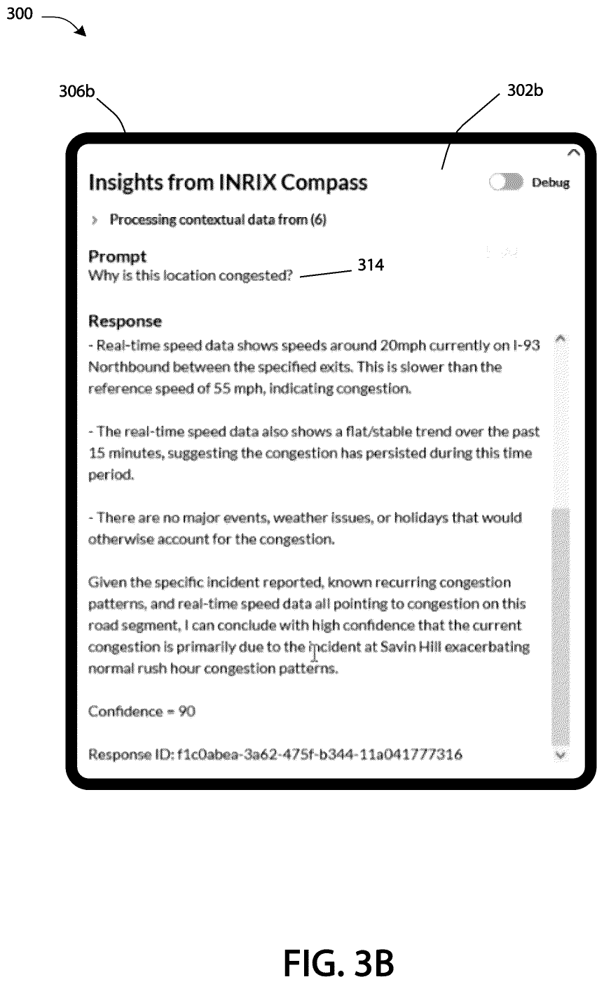

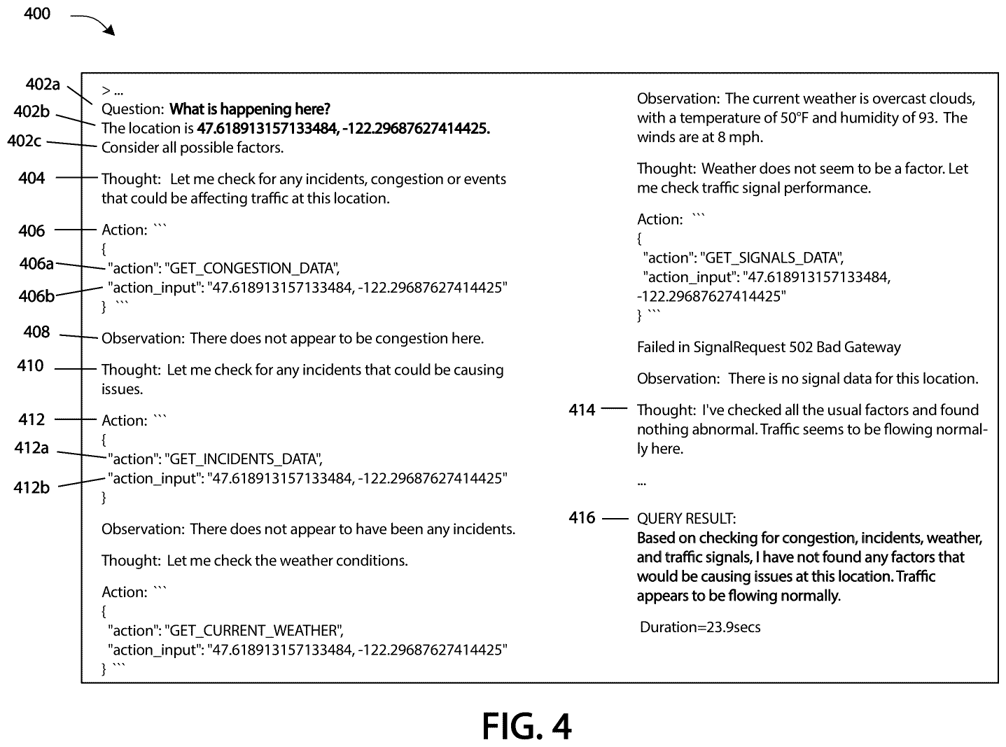

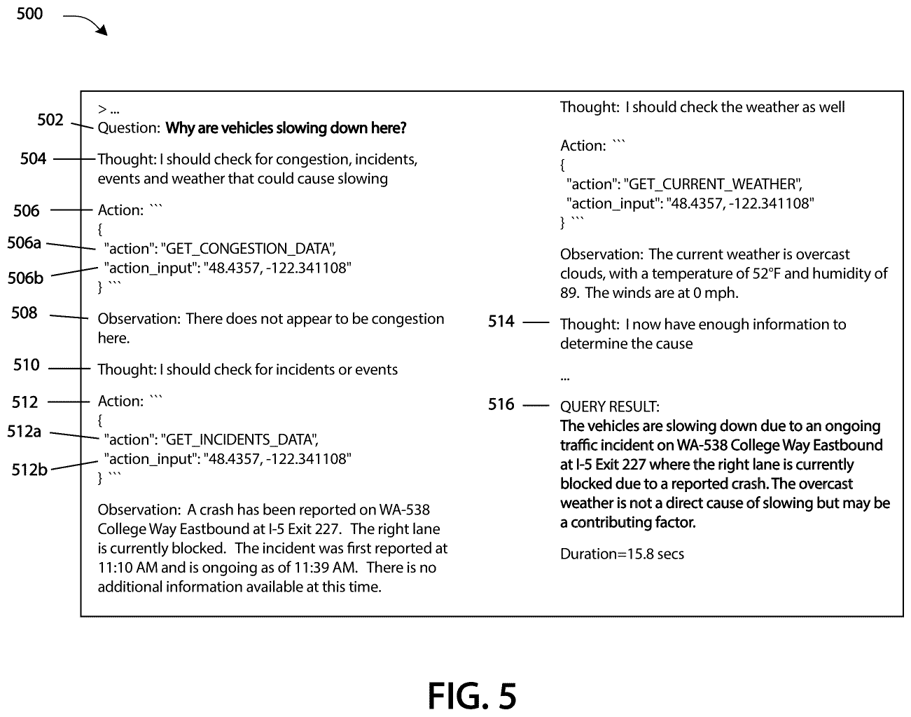

The embodiments described herein provide systems and methods for natural language access and analysis (insight generation) of mobility-related data, using one or more multi-modalities (e.g., text, voice, geospatial data, map data, and/or image input modalities). Embodiments are illustrated by an exemplary method 100 of FIG. 1, and described in conjunction with respect to system 200 of FIGS. 2A and 2B, user interface 302a,b of FIGS. 3A and 3B, and exemplary workflows 400, 500 in FIGS. 4 and 5.

With reference to FIG. 2, system 200 may comprise a manager 202 comprising software, hardware, and/or a combination thereof. In one or more embodiments, manager 202 may be implemented on a computing device, such as for example, one or more servers, one or more virtual machines hosted within a cloud computing environment, a combination thereof, etc. Manager 202 may utilize communication functionality of the computing device to access environment resources, such as data sources/services, such as may reside on remote computing devices accessible to the computing device over a network and/or hosted within the same machine or environment, as the case may be.

In one or more embodiments, manager 202 may comprise a large language model, including in some embodiments a large language model agent. Note that, unless context dictates otherwise, the terms “large language model”, “LLM”, “large language model agent”, and “agent” may be used interchangeably herein. In general, any agent implementation sufficient to provide the functionality described herein may be utilized in the embodiments herein. For example, manager 202 may comprise a LangChain agent, a Guidance agent, etc. Unless context dictates otherwise, the embodiments described herein may be understood as a LangChain ReAct-type agent.

With reference to FIG. 2B, an enlarged block diagram 201 illustrating various aspects of manager 202 is shown. In one or more embodiments, user query information 212 may be input (e.g., used to prompt or task) to manager 202, as via a user interface or otherwise, as described in further detail in connection with embodiments discussed below. User query information may generally comprise a user request (e.g., question, task, etc.) and query context information (e.g., application specific context), also as described in further detail in connection with embodiments discussed below. Core model 202a of manager 202 may reason, using chain-of-thought type analysis or otherwise, to comprehend user query information 212, and to generate a plan or other method to generate a natural language answer responsive to the user request. Agent framework 202b of manager 202 may comprise generally any framework code, modules, components, etc. sufficient to provide the functionality described in the embodiments disclosed herein. For example, in one or more embodiments, agent framework 202b may be configured to build prompts for core model 202a, to construct calls to tools, to execute and handle function calls and flow of control, etc., utilizing one or more models, processes, functions, scripts, components, etc. As will be appreciated by a person of ordinary skill, manager 202 may comprise one or more short and/or long-term memory components (not shown) to store (short and/or long term) context information that is accessible by manager 202 in performing its functions described herein.

Core model 202a may comprise generally any large language-type model sufficient to provide the functionality of the embodiments described herein. For example, in some embodiments, core model 202a may comprise one or more LLM services from Anthropic (e.g., Claude 2), Amazon (e.g., Titan), Meta (Llama 2), Cohere (e.g., Command), AI21 Labs (e.g., Jurassic), etc. In some embodiments, core model 202a may comprise one or more custom LLMs.

With continued reference to FIG. 2B, manager 202 may be communicatively coupled to or otherwise interfaced with one or more tools 214, which are described in further detail in connection with embodiments discussed below. Using the one or more tools 214, manager 202 may interact with one or more environment resources 216. Environment resources 216 may generally comprise anything external to manager 202 that may be accessed via the one or more tools 214. Some non-limiting examples of environment resources 216 are data sources and/or data services (e.g. data services 206), web services (e.g., search engines), APIs, executable code, etc.

In general, in one or more embodiments, manager 202 may generate a plan to answer a user request by performing one or more actions using one or more tools 214. Some non-limiting examples of actions that may be taken via the one or more tools 214 are accessing data (e.g., querying data sources), manipulating data (e.g., requesting observations of data from another model), and/or performing a utility function (e.g. perform a calculation, generate a structured query, etc.), as described in further detail below. The action result may be returned by the tool to the manager (e.g., manager 202), and unless context herein dictates otherwise, in the embodiments described herein, any action result is communicated by a tool (e.g. tool 214) to a manager (e.g., manager 202) in natural language, as described in further detail in connection with the embodiments discussed below. In response to receiving an action result, manager 202 may (via core model 202a, for example) observe (analyze) the action result and may, for example, thereafter plan the next step or steps for it to execute. As described further below, some non-limiting examples of next steps may include: taking further action(s) (e.g., obtaining additional data) via the one or more tools 214, and generating a natural language answer to the user request.

In general, any data and types of data sufficient to provide the functionality described herein may be utilized in the systems and methods disclosed herein. In one or more embodiments, manager 202 may be connected to one or more mobility data sources/services (via, e.g., tools 214). In general, mobility data sources/services may comprise any data directly relevant to mobility—e.g., traffic data, roadway data, pedestrian data, parking data, etc. In some embodiments, manager 202 may also be connected to one or more data sources/services that are indirectly relevant to mobility—e.g., weather data, social media data, event data, etc. As used herein, a “mobility-related data source” may be understood to mean a mobility data source/service and/or a data source/service that is indirectly relevant to mobility.

In general, in the embodiments disclosed herein, mobility-related data sources may be stored and hosted locally and/or remotely, in any manner sufficient to provide the functionality disclosed herein. With reference to FIG. 2A, in some embodiments, mobility-related data sources may be implemented as data lake 204. In general, in one or more embodiments, a data lake may be understood to mean a plurality of data sources/services having a common and/or similar access method, exposure, interface and/or API. For example, data lake 204 may comprise an array of services hosted in a cloud environment and accessed via structured APIs, and may include mobility-related data services, web services (e.g., web search engine service), code execution engine services, etc. In one or more embodiments, the array of hosted data sources/services of data lake 204 may be updated or added to at any time, providing for the extension to new data sources and modalities. As may be appreciated, in the embodiments disclosed herein, data sources 206 in FIG. 2A may be implemented as and/or correspond to environment resources 216 in FIG. 2B, each encapsulated by a tool 214. So, for example, in some embodiments, data source 206a (“Traffic”) in FIG. 2a may correspond to environment resource “A” in FIG. 2B, data source 206b (“Incidents”) may correspond to environment resource “B” in FIG. 2B, etc. As implemented, wherein each environment resource may be encapsulated by a single tool, the descriptions of tools herein may be made by reference to the encapsulated environment resource—e.g., traffic tool 206a, incidents tool 206b, signals tool 206c, visits tool 206d, parking tool 206e, events tool 206f, weather tool 206g, and points of interest tool 206h.

Some additional, non-limiting examples of mobility-related data sources or sets and/or types of data that the systems and methods disclosed herein may utilize include the following: events data (e.g., events in the vicinity of locations); POI data (e.g., points of interest near locations); weather data (e.g., precipitation, temperature, etc., data at locations); incidents data (e.g., data from a traffic agency database, a police report database, an insurance claim database, or other data sources or services); imagery data (e.g., data from a street view service that provides street side imagery and satellite imagery of roads) traffic congestion data (e.g., the volume of traffic in the vicinity of a location); speed data (e.g., measured speeds in the vicinity of a location); route data (e.g., short local routes, longer cross-city routes, long-distance routes between cities); road conditions data (e.g., average speed at locations; volume of traffic for an indicated period of time at locations; average occupancy time of one or more traffic sensors or other locations on a road, such as to indicate the average percentage of time that a vehicle is over or otherwise activating a sensor; one of multiple enumerated levels of road congestion, such as measured based on one or more other traffic condition measures; etc.).

In general, in the embodiments disclosed herein, unless context connotes otherwise, output from an environment resource (e.g., returned data from a data source query) is provided or otherwise returned to the tool in a structured format (e.g., JSON).

Referring now to FIGS. 3A and 3B, system 200 may comprise a user interface, such as graphical user interfaces 302a, 302b. In one or more embodiments, the user interface may be provided by one or more front end applications and/or applications having front end components, such as applications layer 208 (comprising component applications such as, e.g., safety application 210a, signals application 210b, parking application 210c, etc.). In general, applications 208 may be implemented on the same or different computing device(s) and/or computing environments hosting manager 202. In the embodiment illustrated in FIGS. 3A and 3B, graphical user interface 302a,b may be accessed over network 304 via a web browser or portal running on a client device 306a,b. In general, network 304 may comprise one or more wired or wireless local area networks and/or wide area networks (e.g., the Internet), and client device 306a,b may comprise, for example, a mobile device, tablet computer, personal computer, vehicle computing device, etc.

Generally, in the embodiments disclosed herein, the user interface may comprise any mobility-related user interface and/or user interface components such as, e.g., graphical user interface screens, layouts, containers, views, view groups, controls, widgets, elements, etc. (for graphical and image user interfaces), microphones, speakers, etc. (for voice interfaces), and/or any related backend or supporting components such as, e.g., text to language engines or pipelines, speech recognition engines or pipelines, image recognition engines or pipelines, video recognition engines or pipelines, etc., that may be supported or provided by generally any mobility-related front-end system or applications, sufficient to provide the functionality disclosed herein. For example, in the embodiment shown in FIG. 3A, graphical user interface 302a may comprise a traffic management system graphical user interface providing a map portion 310a, contextual information portion 310b, and user query (manager interface) portion 310c. In the embodiment shown in FIG. 3B, graphical user interface 302b may simply comprise user query (manager interface) portion 310b.

In some embodiments, the user interface may comprise, for example, one or more voice user interfaces, tactile user interfaces, multimodal user interfaces, etc. Unless context dictates otherwise, however, any user interface in the embodiments described herein may be understood to be configured (as via one or more recognition engines or pipelines) to output to the manager a natural language text string.

With continued reference to FIG. 3, system 200 may comprise a manager client, such as manager client 212, shown in FIG. 3A. In general, the manager client may comprise any client-side and/or user interface component of system 200 that communicatively couples a user interface, such as user interface 302, to the manager, implemented in any manner sufficient to provide the functionality of the embodiments disclosed herein. For example, in some embodiments, the manager client may comprise a common user interface portion tightly or loosely coupled with applications 208, a module of applications 208 or component interfaced with applications 208, etc., that may handle client-side or user interface interactions with manager 202. In some embodiments, manager client 212 may comprise and/or provide a user interface control, such as button 312, that may launch or invoke a user interface portion, such as user query (manager interface) portion 310c of FIG. 3A.

With reference to FIG. 1, at 102 a manager is provided comprising a large language model communicatively coupled to a user interface. In one or more embodiments, the user interface may comprise a mobility-related user interface, such as the traffic management graphical user interface 302a,b illustrated in FIGS. 3A and 3B. In one or more embodiments, the manager (e.g., manager 202) may be implemented as a large language model agent. In general, any agent implementation sufficient to provide the functionality described herein may be utilized in the embodiments herein. For example, manager 202 may comprise a LangChain agent, a Guidance agent, etc. Unless context dictates otherwise, the embodiments described herein may be understood as a LangChain ReAct-type agent.

At 104, a plurality of tools may be provided that are communicatively coupled to manager 202. In general, as described above, the tools disclosed herein may be implemented as interfaces for the manager to interact with the environment outside the manager (e.g., environment resources 216 in FIG. 2B), and may be implemented in any suitable manner sufficient to provide the functionality herein. In some examples, tools disclosed herein (e.g., tools 214 in FIG. 2B) may comprise objects, functions, chains, pipelines, etc. that may interface/encapsulate environment resources (e.g. data sources/services, components, code, APIs) and may result in or expose a structured API that may receive input (e.g., natural language strings) from a large language model and/or agent framework, may perform one or more operations (e.g., via an encapsulated API) on environment resources (e.g., data lake 204), and may process and/or return to the caller information resulting from the one or more operations.

In general, the tools of the embodiments disclosed herein comprise at least a name property (in natural language) and a description property (in natural language). In some embodiments, the tools may also comprise at least one function (e.g., a call to at least one function of an environment resource). Unless context dictates otherwise, each of the tools described herein may be understood to comprise a single call to a function (and/or an interface to an API call to one function) of one environment resource. For example, in a non-limiting example, a search tool may comprise (in pseudocode):
search=SearchAPIWrapper( )
tool_search=Tool(
name=“search engine search”,
func=search.run,
description=“Use this to get information from a public search engine. You should input a string describing the information you are interested in obtaining. A responsive string is returned. \n”
).

In another non-limiting example, a data access tool (e.g., from an “incidents” data source) may comprise (in pseudocode):
get_incidents_data=getIncidentsData( )
tool_get_incidents_data=Tool(
name=“get incidents data”,
func=get_incidents_data.run,
description=“Use this to get traffic incidents data at this location. You should input a string in format ‘latitude, longitude’, where latitude and longitude describe the location of interest. A JSON string is returned describing the incidents. \n”
).

In another non-limiting example, a data insight tool (requesting llm observations about, e.g., incident causality) may comprise (in pseudocode):
get_causality_with_llm=getCausalityWithLLM( )
tool_get_causality_with_llm=Tool(
name=“get causality with llm”,
func=get_causality_with_llm.run,
description=“Use this to determine the cause of congestion, low speeds, or any other mobility-related incidents. The input MUST include the location and any incident, event, congestion, weather or speed information, and a question about traffic causality. You should input a query string and return a string. \n”
).

Additional, non-limiting, examples of natural language tool descriptions may include descriptions such as: “If you need to know about construction on a road, then use this tool to get that information. Supply me with a lat/long and a time, and I'll tell you about construction near that lat/long”; or, “If you have to make a numerical calculation, I've got a calculator that you can use to make that calculation, and it will make it easier to get numerical results. Supply me with numbers, and what you want to do, and I'll give you an answer”; or “Sometimes there may be complicated things that you want to solve that you may not know how to do, this tool is used to write python code, and execute python code, and I will give you an answer from that python code”, etc.

In general, tool names and descriptions may be predefined or selected in any manner suitable to provide the functionality described herein. In some embodiments, the name may serve simply to uniquely identify the tool to the manager; in some embodiments, the name may also provide descriptive context as to what functions and/or data the tool may access. In some embodiments, the description may provide context to the manager describing at least what type of data may be accessed by the manager via the tool and a description of how the tool operates and/or what parameter(s), data, data types, format, etc. the tool may need to be passed from the manager or otherwise provided in order for the tool to be able to access and/or manipulate its accessible data, or otherwise to be able to call its function(s), as the case may be. In this manner, the name and description may be regarded as a type of natural language interface for the manager to the tools. In some embodiments disclosed herein, tools may comprise custom or standard LangChain tools.

In some embodiments, upon initialization the manager may be provided with each tool's name and description, as well as a function pointer to each tool's implementation, and/or otherwise configured to access (e.g., via an array) the names and descriptions of each tool connected to the manager and configured to be able to invoke, directly or indirectly (e.g., via agent framework code 202b), each tool.

In some embodiments, tools utilized in the embodiments herein may be categorized into at least three types: data access tools, data insight tools, and utility tools. In general, a data access tool may comprise a tool interfacing an API function that may query a connected data source. In some embodiments, a data access tool as used herein may be limited to a tool connected and capable of querying a mobility-related data source in data lake 204. In other embodiments, a data access tool as used herein may comprise a tool capable of accessing a custom data source, such as a third-party data source and/or a non-mobility-related data source. Some non-limiting examples of data access tools that may be utilized in one or more of the embodiments disclosed herein may include: get_signals_data, get_speeds_data, get_events_data, get_events_data, get_incidents_data, get_congestion_data, get_current_weather, etc.

In general, a data insight tool as used herein may comprise a tool interfacing a function that may make observations on the output of at least one other tool (e.g., a data access tool) and/or any other data provided or described, and draw further observations/insights. In one or more embodiments, a data insight tool may comprise a tool that is communicatively coupled to a large language model (via, e.g., an API) and configured to interface at least one function that receives input information (e.g., as a passed parameter or pointer, etc.) comprising the output from at least one data access tool, data, and/or a description of data, and to utilize the input information to prompt the large language model for its insights, and thereafter to output the insights to the manager. In some embodiments, the input information includes additional contextual information such as, e.g., a user query, user request information, etc. Some non-limiting examples of data insight tools that may be utilized in one or more of the embodiments disclosed herein may include: get_causality_with_llm, llm_get_start_location, llm_get_destinations, etc.

In general, a utility tool may comprise a tool interfacing a function that may support data manipulation. For example, in one or more embodiments, the function may comprise a function to perform simple calculations, a function to perform an internet search, a function to generate a query, a function to generate a script or code, a function to validate an answer, etc. Some non-limiting examples of data manipulation tools that may be utilized in one or more of the embodiments disclosed herein may include: get_google_directions, get_road_class, calculator, convert_json_to_text, verify_answer, store_observation, etc.

In some embodiments, at least one of the plurality of tools is a mobility-related tool. In some embodiments, a plurality of the plurality of tools are mobility-related tools. In general, a mobility-related tool is a data access tool in which the associated data source/service that may be queried is a mobility-related data source/service. In some embodiments, each of the mobility-related tools in the plurality of mobility-related tools comprises a mobility-related data source/service that is unique, as a set, to the tool in question.

At 106, the manager may receive a set of user query information. In one or more embodiments, user query information may comprise a user request. In general, in the embodiments disclosed herein, a user request may comprise any suitable request for information and/or insight, in any suitable format or modality, sufficient to interact with the manager (e.g., manager 202) and provide the functionality described herein.

For example, in one or more embodiments, a user request may comprise a natural language text string (e.g., a question) input using a graphical user interface, such as user request 314 (“Why is this location congested?”) in FIGS. 3A and 3B. In some embodiments, a user may input one or more parameters, data, images, files, etc., in addition to a natural language text string. In some embodiments, a natural language text string may be input using another type of modality, such as for example, a voice user interface, an image-to-text user interface, a video-to-text user interface, etc.

In one or more embodiments, user query information may comprise (in addition to a user request) user request contextual information. In general, user request contextual information may comprise any suitable contextual information to the user request sufficient to provide the functionality disclosed herein. In some embodiments, user request contextual information may comprise user specific information, event specific information, application specific information (e.g., application 208), etc., that may be appended to any user requests by the system (e.g., system 200), or otherwise. In some embodiments, user request contextual information may comprise current location information (e.g., latitude, longitude, and timestamp) of a human or automated (e.g., agent sensor) user, such as the user making the user request, of an event (e.g., crash event site), etc. In some embodiments, the application (e.g., application 208) may append user query contextual information (e.g., latitude, longitude information) to a user request.

In some embodiments, user request contextual information may comprise one or more application-standard prompt phrases, text strings and/or parameters. In some embodiments, application-standard prompt phrases, text strings, and/or parameters may serve as the user request of the user query information. For example, in a mobility-related user interface (e.g., user interface 302a), an application control, such as button or pin (e.g., pin 316) associated with a map interface (e.g., user interface 310a) may, when selected by a user, initiate prompting a manager (e.g., manager 202) using, for example, geolocation information (e.g., latitude, longitude) of the pin, as well as timestamp information (e.g., current time) and, in some embodiments, a text phrase (which itself may serve as the user request) such as, e.g., “Why is this location congested?” or “What is occurring here?”, etc.

In general, in the embodiments disclosed herein, the manager may receive user query information (e.g., the set of user query information of step 106) and may create, or cause to be created, a first core model prompt in order to prompt core model (e.g., core model 202a) to generate an answer responsive to the user request of the user query information. For example, in one or more embodiments, one or more components (e.g., agent framework 202b) of the manager may receive user query information and, using one or more models, algorithms, templates, scripts, etc., create a first core model prompt.

In the embodiments disclosed herein, generally any prompt sufficient to provide the functionality described herein may be utilized as a core model prompt. In particular, core model prompts may comprise at least one natural language context instruction and at least one natural language user request appended to the at least one natural language context instruction. In one or more embodiments, core model prompts may comprise ReAct (“Reasoning and Acting”) type of prompts. In some embodiments, core model prompts may comprise core model instructions that establish generally sequential reasoning and acting steps to be performed by the core model until a final reasoning step determines that an answer to the appended user query may be provided or that no answer may be arrived at without more context or information. In some embodiments, the reasoning and acting steps may comprise thought, action, and observation steps, as further illustrated below.

In general, a core model prompt may comprise context having at least one natural language instruction directed to at least each of the following topics: prefix/background information, available tool information, and the overall action and reasoning (task and problem-solving) approach. In addition, a core model prompt may comprise at least the user request from the user query information.

In one or more embodiments, the prefix or background portion of the context may include one or more instructions directed to the personality, expertise, and/or focus that the core model should adopt. In some embodiments, the background portion of the context comprises a mobility-directed expertise instruction. For example, in a non-limiting example, a background instruction may include one or more statements similar to the following: “you are a traffic engineer”, “you have expertise in traffic and mobility and incident management and traffic flow . . . ”, “you are a traffic engineer with expertise in traffic, traffic management, incidents, construction, roads, mobility in general, pedestrian safety, vulnerable road user safety, . . . all of those aspects of managing the traffic network”, etc.

In one or more embodiments, the available tool portion of the context may include one or more instructions that provide at least the name and description of each tool available to be called by the manager, together with a natural language instruction to the core model that it may utilize any of the tools (e.g., “here is a list of tools that you have access to: [name, description] . . . ”).

In one or more embodiments, the overall action/reasoning portion of the context may include one or more instructions that tell the core model what to do with the user query that it will be provided with. In a non-limiting example, an action/reasoning instruction may include one or more statements similar to the following: “you are going to receive a user's query, and I want you to think about which tool to use to answer it, and then when you are ready to do that, I want you to formulate how you talk to the tool in the following way: tell me the name of the tool, and tell me the data that you are going to send to the tool”, or “I am going to provide you with a user's query, and I want you to think about it, think about what tool to use next, and here's what you need to do, once you select the tool—I want you to pick out a tool name, pick out a set of data that you're going to send to that tool, and just send that information back to me”, etc.

The core model prompt may also be provided with at least the user request (e.g., “is the weather impacting traffic today?”, “why is there congestion here?”, etc.) from the user query information. Additionally, in one more embodiments, the core model prompt is provided with an instruction designed to break the core model out of the action/reasoning loop described above, referenced herein as a “stop instruction.” In one or more embodiments, the stop instruction may comprise a direction for the core model to make a determination whether it currently has sufficient information for it to generate a natural language answer responsive to the user request, and if so, to generate an answer and, in some embodiments, to supply the answer to the user (e.g., via the connected user interface). In one non-limiting example, a stop instruction may include one or more statements similar to the following: “If you have now collected enough information to answer the user's query, instead of using a tool, simply answer with ‘here's the final answer’ summarizing everything you've learned and the answer.”

At 108, having been prompted with the core model prompt created in connection with 106, the manager (e.g., the core model component 202a) may generate a plan of action to generate a natural language answer responsive to the first user request. In one or more embodiments, the plan of action may comprise at least an initial analysis or reasoning statement (“thought”) comprising a natural language description of an initial strategy for accessing one or more of the tools (e.g., data tools) and converting their results into a concise natural language answer to the user request. In general, the thought statement may comprise any reasoning (e.g., from chain-of-thought type prompting) sufficient to provide the functionality described herein. For example, FIGS. 4 and 5 provide two non-limiting examples of manager workflows 400 and 500, respectively, according to one or more embodiments disclosed herein. With reference to FIG. 4, the manager (e.g., core model component 202a) generates the initial thought 404 (“Let me check for any incidents, congestion or events that could be affecting traffic at this location”) in response to the user query information comprising user request 402a (“What is happening here”) and user request contextual information 402b (the lat/long of the relevant location) and 402c (application specific prompt, “Consider all possible factors”). With reference to FIG. 5, the manager (e.g., core model component 202a) generates the initial thought 504 (“I should check for congestion, incidents, events and weather that could cause slowing”) in response to the user query information comprising user request 502 (“Why are vehicles slowing down here”). As may be seen, initial thoughts 404 and 504 each comprise a top-line statement reflecting a plan and/or reasoning to solve for a natural language answer responsive to the user request.

Additionally, in one or more embodiments, the plan may comprise identification of a first action by the manager (e.g., core model 202a). In some embodiments, identification of a first action may comprise identification of at least a first action by, for example, identification of a first tool name from the plurality of tools and identification of a first tool input (e.g., argument parameters, values, etc., including a null input) to provide to the first tool. Although not intending to be limiting in the manner in which the first tool may be identified, in one or more embodiments, the manager may generate the name of the tool by understanding the description of each tool, from the plurality of tools, as well as the user request information. For example, with reference to FIGS. 4 and 5, in those non-limiting examples the manager (e.g., core model component 202a) identified first action 406, 506, respectively, to help it accomplish its task of generating a natural language answer to user query 402, 502. As may be seen, the manager there generated the name of the first tool 406a, 506a (“GET_CONGESTION_DATA”) and identified the first tool input 406b, 506b to provide to the tool-namely, in this example, geolocation (lat/long) information supplied in the user query. Note that, in some embodiments, the manager may be configured such that the core model component generates a data structure or object that comprises the first tool identification information (e.g., tool name, tool input), such as, e.g., data structures 406, 506.

At 110, the manager (e.g., manager 202) may call the first tool using a first tool call, wherein the first tool call comprises the first tool name and, in some embodiments, the first tool input. In general, tools may be called by the manager in the embodiments herein in any manner sufficient to provide the functionality described herein. For example, in one or more embodiments, one or more manager components or code (e.g., agent framework 202b) may parse or otherwise access the tool identification information generated by the manager (e.g., core model 202a) after receiving, e.g. a notification, message, event, alert, natural language prompt, etc. that such information has been generated (e.g., as a data structure, object, etc. comprising the tool identification information). With reference to examples provided in FIGS. 4 and 5, tool identification information may comprise, for example, a data structure comprising the name generated by the core model (GET_CONGESTION_DATA at 406a, 506a) for the desired tool and tool input generated by the core model (lat/long 47.6189 . . . , −122.296 . . . at 406b, 506b) representing data/argument to be input to the tool.

In one or more embodiments, after parsing/accessing the tool identification information and extracting/accessing the relevant information (e.g., the first tool name and first tool input), the relevant manager component (e.g., agent framework 202b) may then run the tool using the relevant information. For example, in one or more embodiments, the manager may call the relevant tool using the data lake API corresponding to the identified tool name.

In one or more embodiments, the tool (e.g. the first tool) may then perform the service or function (e.g. GET, query, etc.) on its connected or encapsulated environment resource (e.g., data source, web service, etc.) that it was called to perform, using the tool input passed or otherwise provided to it.

In one or more embodiments, the tool (e.g., first tool) may receive an environment response (output) resulting from the service or function it performed or caused to be performed (e.g., via an API) on the environment resource (e.g., returned data from query run on connected or encapsulated data source). In one or more embodiments, the environment response may comprise a structured data set (e.g., JSON data set).

In one or more embodiments, the tool (e.g., first tool) may interpret the environment response into a natural language tool response and return that to the manager. In general, a natural language tool response may comprise any natural language insight, observation or summary of the environment response.

In general, the tool may interpret the environment response in any manner sufficient to provide the functionality described herein, according to the embodiments disclosed herein. In some embodiments, the tool may run one or more algorithms, scripts, functions, code, etc. to parse the environment response into a natural language tool response. In some embodiments, the tool may call a large language model (the “tool model”) to perform such interpretation. In such embodiments, the tool model may generally comprise any large language model, prompted in any manner, sufficient to provide the functionality described herein. In one or more embodiments, the tool model may comprise a large language model that is different from the manager (e.g., core model 202a), and that is prompted with a tool prompt comprising a simple instruction. For example, in one or more embodiments, the tool may prompt the tool model using a tool prompt similar to the following: “Here is a JSON data structure, I want you to retain all of the important data fields and values, and structure those in a natural language response. Here's the data structure. Go do it.”

At 112, having received a natural language tool response (e.g., the first tool response), the manager (e.g., core model 202a) may perform additional analysis and draw additional conclusions or insights, incorporating the new context (e.g., the tool response information) together with the existing context (e.g., the user query) in its reasoning, a step referenced hereinafter as an “observation” type of analysis. This important function results from the manager's ability to reason across the tool results, producing answers that are not possible within an individual tool. For example, with respect to the non-limiting examples of manager work flows in FIGS. 4 and 5, the manager (e.g., core model component 202a) generated observations 408, 508 (“There does not appear to be congestion here”) in both workflows 400 and 500.

At 114, in one or more embodiments, the manager may generate an additional analysis or reasoning statement (additional “thought”), incorporating the new context (e.g., new observation) together with existing context (e.g., tool response information, any previous observations and thoughts, and previous observations) to determine if it currently does not have sufficient information to generate a natural language answer. If not, the manager may generate an additional plan of action (e.g., a second plan of action) to generate a natural language answer responsive to the user request (i.e. “loop” to 108). In one or more embodiments, the additional plan of action may comprise at least an additional analysis or reasoning statement comprising a natural language description of an additional strategy for accessing one or more of the tools (e.g., data tools) and converting their results into a concise natural language answer to the user request. For example, with respect to the non-limiting examples of manager work flows in FIGS. 4 and 5, the manager (e.g., core model component 202a) generated the additional (second) thought 410 (“Let me check for any incidents that could be causing issues”) as a result of observation 408 and taking into account the entire prior context (e.g., user query information 402, and subsequent analysis and action results). With reference to FIG. 5, the manager in workflow 500 generated the additional (second) thought 510 (“I should check for incidents or events”) as a result of observation 508 and taking into account the entire prior context (e.g., user query information 502 and subsequent analysis and action results).

In addition, the additional plan may comprise identification of an additional action (e.g., a second action) by the manager (e.g., core model 202a). In some embodiments, identification of the additional action may comprise identification of an additional tool (e.g., a second tool) name from the plurality of tools and identification of an additional tool input (e.g., a second argument comprising, for example, parameters, values, etc., including a null input) to provide to the additional tool. Although not intending to be limiting in the manner in which the additional tool may be identified, in one or more embodiments, the manager may generate the name of the tool by understanding the description of each tool, from the plurality of tools, as well as the user request information. For example, with reference to FIGS. 4 and 5, in those non-limiting examples the manager (e.g., core model component 202a) identified second action 412, 512 to help it accomplish its task of generating a natural language answer to user query 402, 502. As may be seen, the manager there generated the name of the second tool 412a, 512a (“GET_INCIDENTS_DATA”) and identified the second tool input 412b, 512b to provide to the tool-namely, in this example, geolocation (lat/long) information supplied in the user query. Note that, in some embodiments, the manager may be configured such that the core model component generates a data structure or object that comprises the additional tool identification information (e.g., second tool name, second tool input), such as, e.g., data structures 412, 512.

The manager may thereafter call the second tool, receive the tool response and form additional observations and thoughts, in the manner described above in relation to 110 and 112, and perform additional actions, in the manner described above in relation to 114, in a loop until it determines that it has sufficient information to generate an answer to the user request, as instructed by the stop prompt.

At 116, if the manager determines that it currently has sufficient information, the manager may generate the natural language answer responsive to the user request. In one or more embodiments, the manager may generate a final analysis (thought) statement that, in lieu of identifying an action, generates an answer to the first user request. For example, and with reference to non-limiting work flow 400 of FIG. 4, after several thought/action/observation iterations, as shown, the manager reasoned that it had sufficient information to answer the user question 402a when it generated the final thought 414 (“I have checked all the usual factors and found nothing abnormal. Traffic seems to be flowing normally here”). Having determined that it had sufficient information, the manager then generated an answer to the user query when it generated query result 416 (“Based on checking for congestion, incidents, weather, and traffic signals, I have not found any factors that would be causing issues at this location. Traffic appears to be flowing normally”). Similarly, with reference to the non-limiting work flow 500 of FIG. 5, after several thought/action/observation iterations, as shown, the manager reasoned that it had sufficient information to answer the user question 502 when it generated the final thought 514 (“I now have enough information to determine the cause”). Having determined that it had sufficient information, the manager then generated an answer to the user query when it generated query result 516 (“The vehicles are slowing down due to an ongoing traffic incident on WA-538 College Way Eastbound at I-5 Exit 227 where the right lane is currently blocked due to a reported crash. The overcast weather is not a direct cause of slowing but may be a contributing factor”).

In one or more embodiments, the manager may provide the answer to the user interface for communication to the user. For example, in some embodiments, the manager may provide the answer to mobility-related (graphical) user interface 302 in FIGS. 3A and 3B. In the non-limiting example illustrated by FIG. 3B, for example, the manager (manager 202) provided the following answer 308 to the graphical user interface 302b: “Given the specific incident reported, known recurring congestion patterns, and real-time speed data all pointing to congestion on this road segment, I can conclude with high confidence that the current congestion is primarily due to the incident at Savin Hill exacerbating normal rush hour congestion patterns.”

Although various examples of the present disclosure are described with respect to interacting with a large language model agent via text strings, embodiments are contemplated in which the interaction may be via multimodal input, such as, for example, images from various sources (e.g., traffic cameras, user mobile phones, etc.), voice input, geospatial information, map data, and video clips, while staying within the scope of the present disclosure.

Implementation of at least some of the disclosed subject matter may lead to benefits including, but not limited to, better management of traffic systems, better response times for traffic managers, deeper understanding of and better insights from large mobility-related data sets, easier querying of large data sets, etc.

Alternatively and/or additionally, implementation of at least some of the disclosed subject matter may lead to benefits including a system that allows private data sets to be easily incorporated into an existing mobility-related LLM agent system, allowing the owner of the private data sets to understand their data and query their data in manners not previously possible.

Alternatively and/or additionally, implementation of at least some of the disclosed subject matter may lead to benefits including improved usability of mobility-related data.

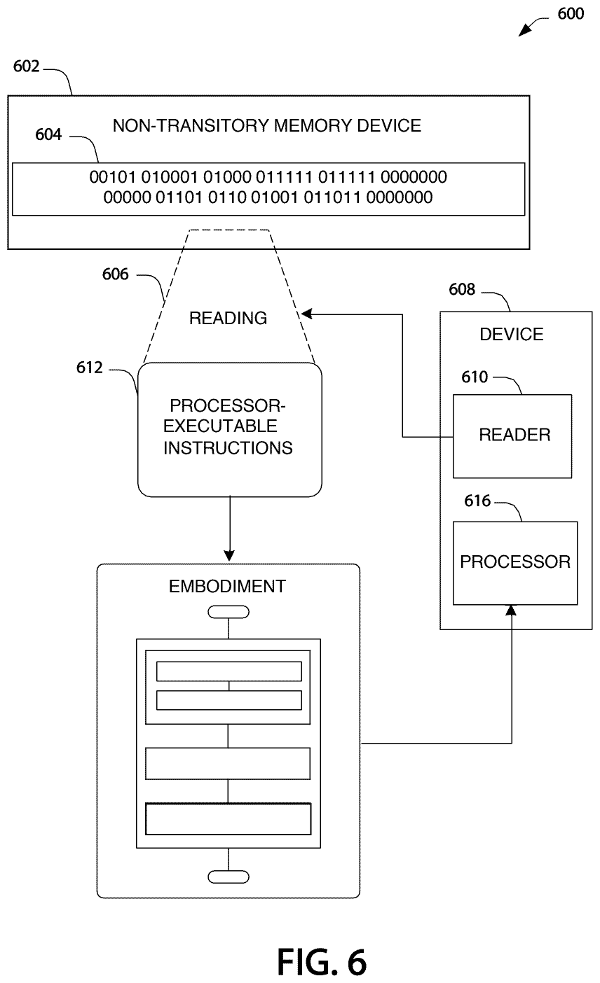

FIG. 6 is an illustration of a scenario 600 involving an example non-transitory machine readable medium 602. The non-transitory machine readable medium 602 may comprise processor-executable instructions 612 that when executed by a processor 616 cause performance (e.g., by the processor 616) of at least some of the provisions herein. The non-transitory machine readable medium 602 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 602 stores computer-readable data 604 that, when subjected to reading 606 by a reader 610 of a device 608 (e.g., a read head of a hard disk drive, or a read operation invoked on a solid-state storage device), express the processor-executable instructions 612. In some embodiments, the processor-executable instructions 612, when executed cause performance of operations, such as at least some of the example method 100 of FIG. 1, for example. In some embodiments, the processor-executable instructions 612 are configured to cause implementation of a system, such as at least some of the example system 200 of FIG. 2, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

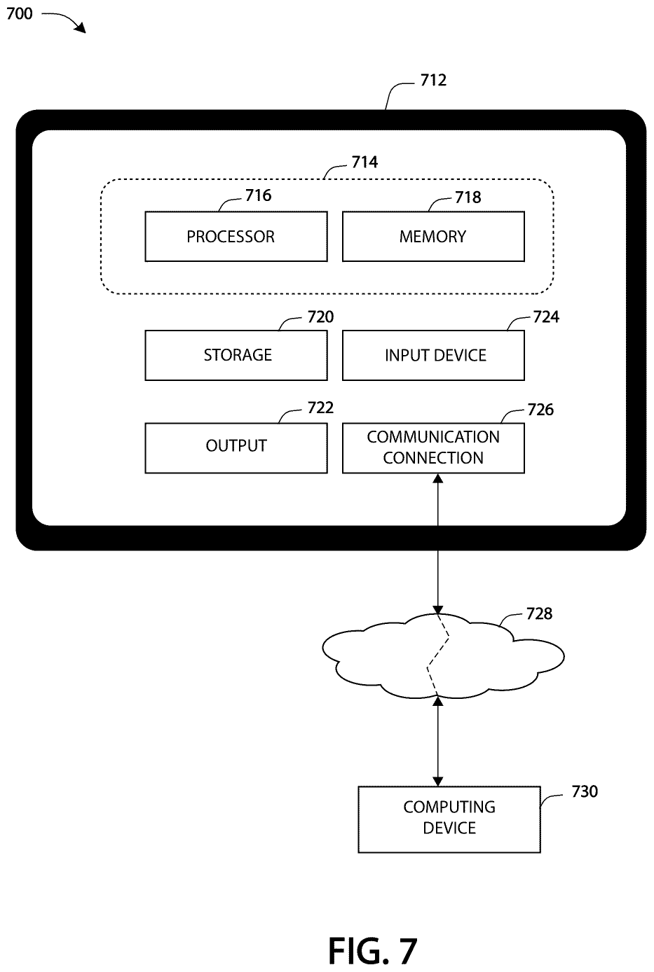

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 700 comprising a computing device 712 configured to implement one or more embodiments provided herein. In a configuration, computing device 712 includes at least one processor 716 and memory 718. Depending on the exact configuration and type of computing device, memory 718 may be volatile (such as RAM, for example), nonvolatile (such as ROM, flash memory, etc., for example) or some combination of the two. This configuration is illustrated in FIG. 7 by dashed line 714.

In other embodiments, device 712 may include additional features and/or functionality. For example, device 712 may also include additional storage (e.g., removable and/or non-removable) including, but not limited to, magnetic storage, optical storage, and the like. Such additional storage is illustrated in FIG. 7 by storage 720. In an embodiment, computer readable instructions to implement one or more embodiments provided herein may be in storage 720. Storage 720 may also store other computer readable instructions to implement an operating system, an application program, and the like. Computer readable instructions may be loaded in memory 718 for execution by processor 716, for example.

The term “computer readable media” as used herein includes computer storage media. Computer storage media includes volatile and nonvolatile, removable and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 712. Computer storage media does not, however, include propagated signals. Rather, computer storage media excludes propagated signals. Any such computer storage media may be part of device 712.

Device 712 may also include communication connection 726 that allows device 712 to communicate with other devices. Communication connection 726 may include, but is not limited to, a modem, a Network Interface Card (NIC), an integrated network interface, a radio frequency transmitter/receiver, an infrared port, a USB connection, or other interfaces for connecting computing device 712 to other computing devices. Communication connection 726 may include a wired connection or a wireless connection. Communication connection 726 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 712 may include input device 724 such as keyboard, mouse, pen, voice input device, touch input device, infrared cameras, video input devices, and/or any other input device. Output device 722 such as one or more displays, speakers, printers, and/or any other output device may also be included in device 712. Input device 724 and output device 722 may be connected to device 712 via a wired connection, wireless connection, or any combination thereof. In an embodiment, an input device or an output device from another computing device may be used as input device 724 or output device 722 for computing device 712.

Components of computing device 712 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 712 may be interconnected by a network. For example, memory 718 may be comprised of multiple physical memory units located in different physical locations interconnected by a network.

Those skilled in the art will realize that storage devices utilized to store computer readable instructions may be distributed across a network. For example, a computing device 730 accessible via a network 728 may store computer readable instructions to implement one or more embodiments provided herein. Computing device 712 may access computing device 730 and download a part or all of the computer readable instructions for execution. Alternatively, computing device 712 may download pieces of the computer readable instructions, as needed, or some instructions may be executed at computing device 712 and some at computing device 730.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above-described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
providing a manager comprising a first large language model communicatively coupled to a user interface;
providing a plurality of tools communicatively coupled to the manager, wherein each of the plurality of tools is configured to provide the manager with a natural language tool name that identifies the tool and a natural language description that describes the tool;
receiving, by the manager, a set of user query information comprising a user request;
generating, by the manager, a first plan to generate a natural language answer responsive to the user request, wherein the first plan comprises identification of a first action, wherein identification of a first action comprises identification of a first tool name from the plurality of tools and identification of a first tool input to provide to the first tool;
calling, by the manager, the first tool using a first tool call, wherein the first tool call includes the first tool name and the first tool input;
observing, by the manager, a first tool response, wherein the first tool response comprises a natural language observation of the information returned from the first tool;
determining, by the manager, whether the manager currently has sufficient information to generate the natural language answer responsive to the user request;
if the manager determines that it does not currently have sufficient information, generating, by the manager, an additional plan to generate a natural language answer responsive to the user request, wherein the additional plan comprises identification of an additional action, wherein the identification of an additional action comprises identification of an additional tool name from the plurality of tools and identification of an additional tool input to provide to the additional tool; and
if the manager determines that it currently has sufficient information, generating, by the manager, the natural language answer responsive to the user request and providing the natural language answer responsive to the user request to the user interface.

2. The method of claim 1, wherein each of the plurality of tools is configured to interface a tool data source comprising a data set that is unique, as a set, to the tool and that is mobility-related.

3. The method of claim 1, wherein a plurality of the plurality of tools are each configured to interface a tool data source comprising a data set that is unique, as a set, to the tool and that is mobility-related.

4. The method of claim 1, wherein a tool from the plurality of tools is configured to interface a large language model and to prompt the large language model.

5. The method of claim 1, wherein a tool from the plurality of tools is configured to interface a component that provides a utility function.

6. The method of claim 1, wherein the user interface is a mobility-related graphical user interface.

7. The method of claim 1, wherein the user interface is a multimodal user interface.

8. The method of claim 2, wherein the first tool comprises a second large language model and is configured to prompt the second large language model using a tool prompt.

9. The method of claim 8, wherein the first tool, when called by the first tool call, retrieves a structured data set from the data source and prompts the second large language model to interpret the structured data set to a natural language tool response.

10. The method of claim 2, wherein the user interface is a traffic management system graphical user interface.

11. A computing device comprising:
a processor; and
memory comprising processor-executable instructions that when executed by the processor cause performance of operations, the operations comprising:
providing a manager comprising a first large language model communicatively coupled to a user interface;
providing a plurality of tools communicatively coupled to the manager, wherein each of the plurality of tools is configured to provide the manager with a natural language tool name that identifies the tool and a natural language description that describes the tool;
receiving, by the manager, a set of user query information comprising a user request;
generating, by the manager, a first plan to generate a natural language answer responsive to the user request, wherein the first plan comprises identification of a first action, wherein identification of a first action comprises identification of a first tool name from the plurality of tools and identification of a first tool input to provide to the first tool;
calling, by the manager, the first tool using a first tool call, wherein the first tool call includes the first tool name and the first tool input;
observing, by the manager, a first tool response, wherein the first tool response comprises a natural language observation of the information returned from the first tool;
determining, by the manager, whether the manager currently has sufficient information to generate the natural language answer responsive to the user request;
if the manager determines that it does not currently have sufficient information, generating, by the manager, an additional plan to generate a natural language answer responsive to the user request, wherein the additional plan comprises identification of an additional action, wherein the identification of an additional action comprises identification of an additional tool name from the plurality of tools and identification of an additional tool input to provide to the additional tool; and
if the manager determines that it currently has sufficient information, generating, by the manager, the natural language answer responsive to the user request and providing the natural language answer responsive to the user request to the user interface.

12. The computing device of claim 11, wherein each of the plurality of tools is configured to interface a tool data source comprising a data set that is unique, as a set, to the tool and that is mobility-related.

13. The computing device of claim 11, wherein a plurality of the plurality of tools are each configured to interface a tool data source comprising a data set that is unique, as a set, to the tool and that is mobility-related.

14. The computing device of claim 11, wherein a tool from the plurality of tools is configured to interface a large language model and to prompt the large language model.

15. The computing device of claim 11, wherein a tool from the plurality of tools is configured to interface a component that provides a utility function.

16. The computing device of claim 11, wherein the user interface is a mobility-related graphical user interface.

17. The computing device of claim 11, wherein the user interface is a multimodal user interface.

18. The computing device of claim 12, wherein the first tool comprises a second large language model and is configured to prompt the second large language model using a tool prompt.

19. The computing device of claim 18, wherein the first tool, when called by the first tool call, retrieves a structured data set from the data source and prompts the second large language model to interpret the structured data set to a natural language tool response.

20. The computing device of claim 12, wherein the user interface is a traffic management system graphical user interface.

21. A non-transitory machine readable medium having stored thereon processor-executable instructions that when executed cause performance of operations, the operations comprising:
providing a manager comprising a first large language model communicatively coupled to a user interface;
providing a plurality of tools communicatively coupled to the manager, wherein each of the plurality of tools is configured to provide the manager with a natural language tool name that identifies the tool and a natural language description that describes the tool;
receiving, by the manager, a set of user query information comprising a user request;
generating, by the manager, a first plan to generate a natural language answer responsive to the user request, wherein the first plan comprises identification of a first action, wherein identification of a first action comprises identification of a first tool name from the plurality of tools and identification of a first tool input to provide to the first tool;
calling, by the manager, the first tool using a first tool call, wherein the first tool call includes the first tool name and the first tool input;
observing, by the manager, a first tool response, wherein the first tool response comprises a natural language observation of the information returned from the first tool;
determining, by the manager, whether the manager currently has sufficient information to generate the natural language answer responsive to the user request;
if the manager determines that it does not currently have sufficient information, generating, by the manager, an additional plan to generate a natural language answer responsive to the user request, wherein the additional plan comprises identification of an additional action, wherein the identification of an additional action comprises identification of an additional tool name from the plurality of tools and identification of an additional tool input to provide to the additional tool; and
if the manager determines that it currently has sufficient information, generating, by the manager, the natural language answer responsive to the user request and providing the natural language answer responsive to the user request to the user interface.
